(19) United States
(12) Patent Application Publication
(10) Pub. No.: US 2024/0289876 A1
(43) Pub. Date: Aug. 29, 2024

(54) SYSTEMS AND METHODS FOR AUTOMATICALLY GENERATED DIGITAL PREDICTIVE INSIGHTS FOR USER INTERFACES

(71) Applicant: THE TORONTO -DOMINION BANK, Toronto (CA)

(72) Inventors: Sangeeta Mathew, Mississauga (CA); Dalbir Channa, Markham (CA); Samiksha Makhijani, Toronto (CA); Farnush Farhadi Hassan Kiadeh, Toronto (CA); Jianing Sun, Toronto (CA); Saba Zuberi, Toronto (CA); Linda Ling Tao, Toronto (CA); Patrick James Whelan, Oakville (CA)

(21) Appl. No.: 18/173,878

(22) Filed: Feb. 24, 2023

(51) Int. Cl. G06Q 40/02; G06F 3/04817; G06N 3/08

(52) U.S. Cl. CPC G06Q 40/02; G06F 3/04817; G06N 3/045; G06N 3/08

(57) ABSTRACT

The disclosed embodiments include computer-implemented systems, apparatuses, and processes that automatically generate and provision for presenting actionable icons on a graphical user interface (GUI) of a computer device. The method includes providing electronic data transfers and attributes to a predictive machine learning model to predict future data transfers and data transfer trends; dynamically determining prior factors historically influencing data transfers and thereby a set of factors likely to influence the predicted future data transfers; automatically triggering a digital nudge to the computer device, across a communications network, to automatically present the predicted future data transfers and the set of factors as one or more interactive visual insight icons on the graphical user interface; and, responsive to a determination of engagement with the visual insight icons, triggering generating one or more action icons on the graphical user interface, customized to adjusting the predicted future data transfers.

### FIELD

The present disclosure relates to automatically generated enhanced predictive digital content and insights for generated interactive computer interfaces and more particularly to a system and method utilizing machine learning to generate the automated predictive digital content and computerized actions.

### BACKGROUND

Application users using online transaction applications, websites and computing resources have a need for personalized online information when accessing the software applications and websites. Current approaches provide differing quantified insights lack trust of users as they often utilize black box or ad-hoc methods to offer any insights and lack personalization. Additionally, current approaches lack ability to be multi-dimensional and process different types of information, thereby being inaccurate.

In addition, many approaches may also be computationally intensive and require significant analysis as they lack reasoning for any digital advice provided and thus, they are less likely to be implemented as their information lacks trust and reliability. Conventional digital content distribution systems are inflexible and unable to adjust to changing needs of networked client devices and data transfer systems.

### SUMMARY

Computational systems, methods, devices and techniques are disclosed in various embodiments whereby computing systems are configured to automatically provide transaction related digital content including insight information and future predictive performance metrics for the transactions to an interactive user interface (e.g. a graphical user interface) of a client device. The disclosure also provides, in at least some embodiments, computing systems, device and methods configured to provide icons on a graphical user interface (GUI) of a computer system with personalized user insights and presenting icons with actions based on the predicted insight information.

In at least some implementations, end users using online applications and computing resources have a need for enhanced personalized insights into historical and future forecasted or predicted transaction events. Additionally, in some aspects, such insights need to convey the computing methods and systems by which such a predicted insight was deduced so that they may be trusted and interacted with on a user interface. Additionally, in at least some aspects, there is a need to provide graphical user interface content and associated interface icons providing insights such as relating to digital assets which do not simply focus on a single dimension of information, e.g. categorized spending assessments, without adequately analysing or proving insights on other dimensions of transaction data such as predicted cash-flow.

Additionally, there is a need, in at least some aspects, to provide a computing system and method which can alter the type of digital content and insight provided to end users based on particular digital behaviours (e.g. customized to behaviours) and provide a sufficient level of accuracy in its analysis models to provide a detailed breakdown of predicted insights on interactive user interfaces to users.

It is desirable to have a computer tool that assesses historical transaction behaviours and activities associated with one or more computing devices and predicts future transactions, e.g. digital asset flow including fixed and variable expenses, to provide specific personalized insights into customer transactions such as cash-flow, which alters the type of insight provided based on the particular circumstances of the customer. In addition, it is desirable that such a computer tool provides predictive insights at a level of accuracy that allows for a detailed display of predictive cash-flow insights.

In some aspects, there is provided a context-aware machine learning computer model and system that analyzes individual transaction behaviours in order to contextualize the customer insight, predicts future data transfers, and provides customized digital insights and associated content and icons into future trends for a particularly generated customized user interface. Aspects of the disclosure use mixed machine learning models for different types of data transfer predictions to increase the accuracy of the predictions compared to prior methods.

In one aspect, there is provided a computer system for presenting actionable icons on a graphical user interface (GUI) of a computer device, the computer system comprising: at least one processor; and a memory in communication with the at least one processor, the memory storing instructions, that when executed by the at least one processor, configure the system to: track electronic data transfers comprising interactions between one or more data records and data transfer attributes comprising types of data transfers and associated computing devices performing the data transfers; provide the electronic data transfers and attributes to a predictive machine learning model having at least one neural network to predict future data transfers and data transfer trends associated with the one or more data records, the model being trained on prior historical data transfers comprising historical changes to the data records and historical data transfer attributes; dynamically determine from the predicted data transfer trends of the machine learning model and the historical data transfers, prior factors historically influencing data transfers and thereby a set of factors likely to influence the predicted future data transfers; automatically trigger a digital nudge to the computer device, across a communications network, to automatically present the predicted future data transfers and the set of factors likely to influence the predicted future data transfers as one or more interactive visual insight icons on the graphical user interface for subsequent engagement; and, responsive to a determination of engagement with the one or more interactive visual insight icons on the computer device, the processor triggering generating one or more action icons on the graphical user interface of the computer device, the action icons customized to adjusting the predicted future data transfers and the data transfer trends.

In one aspect, data transfer attributes comprise: movement of data transfers between the one or more data records, and at least one credit and one debit posting in the one or more data records.

In one aspect, triggering the presenting further comprises: trigger presenting of the set of factors alongside prior factors historically influencing the data transfers on the graphical user interface for subsequent engagement.

In one aspect, a determination of engagement, further comprises: tracking feedback input received on the graphical user interface of the computer device comprising: determining whether a positive response indicating the visual insight icons comprising a set of data transfer insights as helpful; a neutral response indicating the visual insight icons comprising the data transfer insights were not interacted with; or a negative response indicating the visual insight icons comprising the data transfer insights were unhelpful was received on the graphical user interface of the computer device.

In one aspect, wherein the instructions further configure the system to: transmit the feedback input to the predictive machine learning model to invoke the predictive machine learning model to revise the training of the model based on the feedback input and thereby update the set of factors; and, responsive to retraining the model, trigger the graphical user interface of the computing device to display an updated visual insight icons comprising the updated set of factors.

In one aspect, presenting the visual insight icons further comprises the instructions configuring the system to: dynamically generate content for the visual insight icons further based on: extracting, from a database, profile attributes of a user associated with the electronic data transfers for the one or more data records; determine, from the database, similar users based on the profile attributes of the user; grouping the similar users into clusters on the database; and responsive to said grouping, generate similar content for the visual insight icons for the similar users based on historical knowledge of insights having a positive rating by prior users.

In one aspect, the instructions further configure the system to: determine, from the predictive machine learning model, a degree of confidence related to the predicted future data transfers and retrieve a set of corresponding templates from the database for presenting the one or more interactive visual insight icons based on the degree of confidence wherein each of the templates is defined as associated with a range of degree of confidence.

In one aspect, generating the one or more action icons further comprises the instructions configuring the system to: dynamically determine one or more potential actions relating to interacting with the one or more data records to improve the predicted future data transfers associated with the one or more data records, and present the actions as content for the action icons to graphical user interface of the computing device.

In one aspect, the instructions further configure the system to: select a first trained neural network from a plurality of trained neural networks to predict the future data transfers based on the data transfer attributes, wherein different predicted future data transfers are predicted associated with a particular category of data transfer attributes.

In one aspect, first trained neural network comprises at least one of: a regression model, a rule-based model, and a decision tree based ensemble model using gradient boosting framework.

In one aspect, the instructions further configure the system to: determine a confidence score for the set of factors likely to influence the predicted future data transfers; and dynamically manage and adjust a presentation of insights presented in the one or more interactive visual insight icons on the graphical user interface based on the determined confidence score of the set of factors.

In one aspect, there is provided a computer implemented method for presenting actionable icons on a graphical user interface (GUI) of a computer device, the method comprising: tracking, by a processor of a computer system, electronic data transfers comprising interactions between one or more data records and data transfer attributes comprising types of data transfers and associated computing devices performing the data transfers; providing, by the processor, the electronic data transfers and attributes to a predictive machine learning model having at least one neural network to predict future data transfers and data transfer trends associated with the one or more data records, the model being trained on prior historical data transfers comprising historical changes to the data records and historical data transfer attributes; dynamically determining by the processor, from the predicted data transfer trends of the machine learning model and the historical data transfers, prior factors historically influencing data transfers and thereby a set of factors likely to influence the predicted future data transfers; automatically triggering by the processor a digital nudge to the computer device, across a communications network, to automatically present the predicted future data transfers and the set of factors likely to influence the predicted future data transfers as one or more interactive visual insight icons on the graphical user interface for subsequent engagement; and, responsive to a determination of engagement with the one or more interactive visual insight icons on the computer device, the processor triggering generating one or more action icons on the graphical user interface of the computer device, the action icons customized to adjusting the predicted future data transfers and the data transfer trends.

In one aspect, there is provided a system comprising: a prediction engine comprising: a plurality of neural network models each configured to determine for a corresponding category of data transfer between computing devices comprising fixed and variable incoming and outgoing data transfers in an input data transfer data set, a predicted set of future data transfers comprising: a future data transfer value for a future time period within each said category of data transfer and an associated confidence score for the future data transfer value being predicted, each neural network model trained for a particular category of data transfer with prior historical data transfer data; a profiling module for determining historical user profiles similar to a user profile associated with the input data transfer data set; an insight generation module to produce from the future data transfer value for each said category of data transfer and the historical user profiles, a set of potential interactive visual insights for display on a user interface associated with a computing device of the input data transfer data set; a content generation module to produce customized interactive content on the user interface selected based on the set of potential interactive visual insights and the confidence score, the customized interactive content being presented on the user interface as visual insight icons for selection and engagement on the user interface; and, a feedback detection module to track engagement on the user interface with the visual insight icons and generate a set of action icons on the user interface, the action icons selected to perform a set of data transfers determined, by the feedback detection module, to improve the predicted set of future data transfers based on the engagement on the user interface.

### BRIEF DESCRIPTION OF THE DRAWINGS

These and other features of the invention will become more apparent from the following description in which reference is made to the appended drawings wherein:

FIG. 1A shows an example schematic block diagram of a computerized content delivery system utilizing a neural network framework, according to one embodiment.

FIGS. 1B and 1C illustrate example predictive machine learning model generation and training parameters including target definition and training/test/validation data splitting.

FIG. 2 illustrates a schematic diagram of an example process for generating predictive insights, nudges and personalized actions on an example generated graphical user interfaces (GUI) or portions thereof as may be generated by the computerized content generation system of FIG. 1A, according to one embodiment.

FIGS. 3, 4A-4C, and 5A-5B are diagrams illustrating example graphical user interfaces generated by the computerized content delivery system of FIG. 1A, according to various example embodiments.

FIG. 6 illustrates an example flow of operations for the content delivery system of FIG. 1A, according to one embodiment.

### DETAILED DESCRIPTION

Generally, in one implementation, there is provided a computer method and system using predictive machine learning for monitoring data transfers and transaction activity relating to one or more computer devices and associated data as may be stored within central database systems and database records, including customer data records and generating customized user interfaces based on predictive modelling which display data transfer trends, behaviours and expected future trends as well as electronic or digital objects providing insight content generated on user interfaces and corresponding electronic action icons for performing actions, such as to improve the data transfer patterns predicted. In one implementation, the proposed system and method monitors and analyses changes to one or more database records within one or more database system relating to data transfers, such as customer data records including account balances and associated data including transactions between one or more computing devices in a networked computing environment. In one example, the data transfer records may relate to debiting and crediting the one or more customer data records. In at least some implementations, the data transfers being tracked between computing devices such as within data transfer records of database systems may be applied to a neural network model configured to predict future data transfers and determine insights, based on other user behaviours monitored and tracked to improve the data transfers and when interacted with, such insights on a particular user interface device, are configured to trigger subsequent actions on the customized user interface for improving the data transfer patterns in a subsequent time period. For example, such data transfers may be applied, in at least some aspects to a neural network configured to predict data transfers including future cash-flows and provide data transfer insights, e.g. cash-flow insights on to customers as well as corresponding computerized actions, displayed in the form of one or more selectable computer icons on the generated graphical user interface via one or more screens relating to the insights from the predictive modelling, such as for improving such trends predicted.

In at least some implementations, the present disclosure relates to systems, methods, and non-transitory computer readable media for utilizing an artificial intelligence framework, including a set of neural network models for predicting different types of data transfers over a future time period and for generating enhanced digital content on interactive graphical user interfaces of computing devices including digital insights and selectable actions based on the predictions for improving the predictions in a subsequent time interval or iteration.

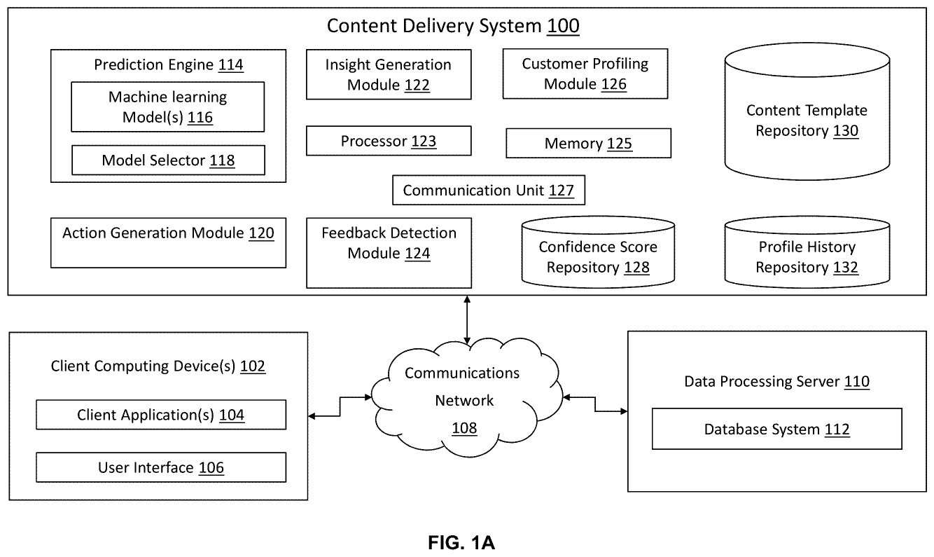

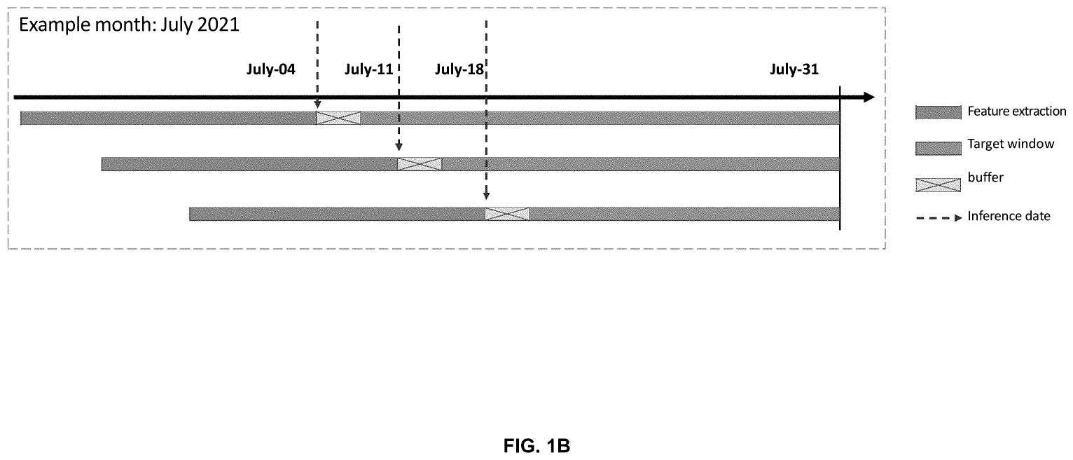

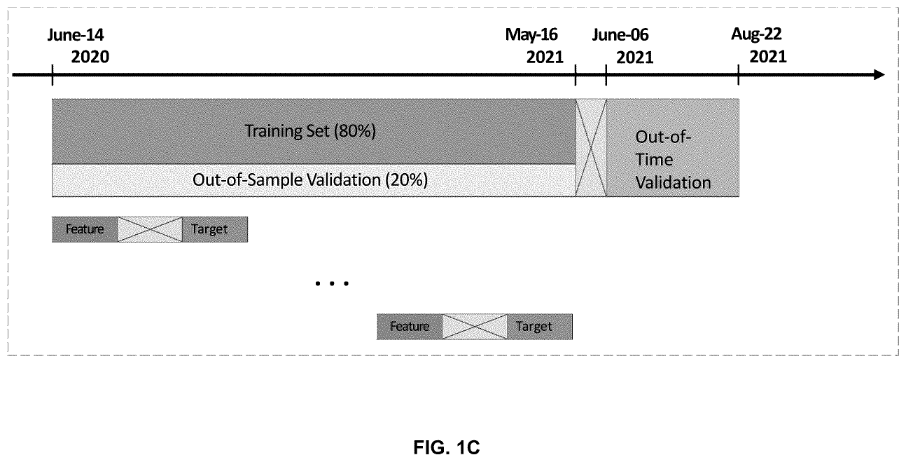

Referring to FIG. 1A, shown is a schematic diagram of an example computing environment for implementing a digital content delivery system 100, in accordance with one or more embodiments configured to determine and generate customized digital content on associated customized graphical user interfaces, such as client computing devices 102, using an artificial intelligence framework. In particular, the digital content may comprise predictive content such as performance metrics relating to data transfers in a future time period, and metadata defining at least one reasoning for the prediction and digital actions delivered for presentation onto graphical user interfaces of the one or more associated computing devices, such as client computing devices 102, across one or more communications network 108. As illustrated in FIG. 1A, the content delivery system 100 may communicate with a data processing server 110, and one or more client computing devices 102, across a communications network 108. For example, in one implementation, the data processing server 110 may comprise one or more processors, a memory storing processor executable instructions and a database system 112 managed by the processors. Additionally modules of the data processing server 110 are not shown to avoid undue complexity of the drawings. The database system 112 may store data records relating to data transfers, such as transactions between different clients computing devices 102 including from a source to a destination. Such data record transactions may include in one example use, data relating to payment systems and communications between client computing devices 102 with data records held on each devices and with data records on other devices (e.g. between merchant engine and client device 102). In one implementation, the database systems 112 may include data records relating to cash flows, and cash flow attributes (e.g. fixed or variable expenses; types of merchant, etc.) for each transaction on each of the data records on the client computing device 102 as may be held for a particular entity of interest for which the client application 104 is configured to display digital content relating to data records for the client computing device 102 with the assistance of the content delivery system 100 providing dynamic, and real-time content including predictive content for display on a user interface 106 associated with the client application 104.

In one example implementation, the data processing server 110 tracks and stores within the database system 112, changes or indications of data transfers for one or more client computing devices 102, associated data transfers and attributes (e.g. a type of data transfer such as variable, fixed or continuous, data relating to a source or destination devices for the transfer, frequency of transfer, quantity of transfer, associated computing devices within the networked environment of FIG. 1A performing the data transfers, and associated e-commerce objects or products related to the transfer, etc.). Such data transfers may include transactions between client computing devices 102 or transactions between different data records within a particular client computing device 102 and client application 104.

In one example, the data transfer data stored within the database system 112, may include data records containing data transfer changes. In one example, this may include data records for data transfer changes such as relating to transaction changes including cash flow changes, cash flow attributes (e.g. fixed or variable expenses or other categorization of the data transfer), for one or more customer account balances including increases or decreases in account balance as performed by and relating to client computing devices 102. Additionally, in some aspects, the data records for data transfers may include associated data relating to transactions between a source and a destination, e.g. debiting and crediting the one or more customer data records being tracked. Attributes for the data transfers being monitored, tracked and stored within the data processing server 110 may include data and information relating to the source, frequency, and quantity of data transfers; and the frequency, quantity, and e-commerce objects involved in the data transfer).

Although one example implementation of the disclosed methods and systems may relate to data transfers relating to financial transactions and associated attributes for the transactions, other types of electronic data transfers, such as by one or more client computing devices 102 across the communications network 108, may be monitored, tracked and used for prediction of digital content by the content delivery system 100 and associated actions for display on a customized graphical user interface of the client computing device 102. Such digital data transmission data signals may be sent and received using binary code across the environment of FIG. 1A. Therefore, in at least some aspects, the data processing server 110 may include processors, memory and instructions for implementing one or more transaction systems for processing and analyzing data transfers in the environment of FIG. 1A, including but not limited to, data communication systems, social networking systems, e-commerce transaction systems, data security systems, digital asset systems, financial transaction systems, and may use different storage systems along with the database system 112, and associated authentication, security and formatting techniques, and/or various different techniques for processing the transaction data including based on the respective characteristics of the hardware and/or software system(s) used within the environment of FIG. 1A.

The content delivery system 100 may analyze and process secure data transfers and other transaction related data (e.g. including monitoring online behaviour of users interacting with client applications 104 on the client computing device 102 and/or interacting with other computing devices 102 and data processing server 110 to perform transactions) within various computing and networking environments, such as the environment of FIG. 1A, as retrieved by and/or otherwise accessed from data processing server 110. In some example aspects, the content delivery system 100 may be configured to only track and monitor data transfers for digitally active users of client computing devices 102, such as those having had at least a defined number of digital transactions in a given time period.

The content delivery system 100 comprises a prediction engine 114, a computerized action generation module 120, an insight generation module 122, a processor 123, a feedback detection module 124, a memory 125, a communication unit 127, a customer profiling module 126, a confidence score repository 128, a content template repository 130, and a profile history repository 132. In turn, the prediction engine 114 comprises one or more machine learning model 116, and a model selector 118.

The content delivery system 100 may comprise additional computing modules or data stores in various embodiments. Additional computing modules and devices that may be included in various embodiments, are not shown in FIG. 1A to avoid undue complexity of the description, such as communication with one or more other computing devices, internal communication with various modules, operating system, etc. as applicable, for performing the operations described herein.

Components of the content delivery system 100 may include software, hardware and/or both. One or more processors 123 may implement functionality and/or execute instructions stored within a computer readable storage medium including a memory 125 and/or other computing modules of the content delivery system 100 within a computing device implementing the content delivery system 100. For example, processor(s) 123 may be configured to receive instructions and/or data from storage device(s), including memory 125 and various storage units associated with the modules of the content delivery system 100 to execute the functionality of the modules shown in FIG. 1A, among others (e.g. operating system, applications, etc.). Content delivery system 100 may store data/information (e.g. historical data transfers; historical user interface interactions and patterns; feedback from various computing devices 102; confidence scores; content templates for the digital content generated, etc.) to one or more storage device(s) including but not limited to the memory 125, content template repository 130, profile history repository 132 and confidence score repository 128. When executed by the one or more processors 123, the computer executable instructions stored within the memory 125 and/or other storage modules of the content delivery system 100 may thus cause the content delivery system 100, to perform the methods described herein. That is, the instructions (e.g. as stored within the memory 125) are configured, when executed by the one or more processors 123, to perform any of the methods described herein.

The one or more storage devices, including the memory 125 may take different forms and/or configurations, for example, as short-term memory or long-term memory. Memory 125 may be configured for short-term storage of information as volatile memory, which does not retain stored contents when power is removed. Volatile memory examples include random access memory (RAM), dynamic random access memory (DRAM), static random access memory (SRAM), etc. Memory 125, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable read-only memory (EPROM) or electrically erasable and programmable read-only memory (EEPROM).

One or more communication units 127 may communicate with external computing devices, e.g. other client computing devices 102 and/or data processing server 110 via one or more networks 108 by transmitting and/or receiving network signals on the one or more networks. The communication units 127 may include various antennae and/or network interface cards, etc. for wireless and/or wired communications.

Referring back to FIG. 1A, the content delivery system 100 and the data processing server 110 may each represent a computing system that includes one or more computing devices or servers (e.g. not shown in FIG. 1A) such as a special purpose processing device and tangible, non-transitory memory devices storing executable code and application modules for perform the functions described herein.

Other examples of the content delivery system 100 may be a specialized computer including but not limited to: a tablet computer, a personal digital assistant (PDA), a laptop computer, a tabletop computer, a portable media player, an e-book reader, a watch, a customer device, a user device, or another type of computing device configured specifically as described herein to contain hardware and/or software modules to perform the example computing operations described and illustrated modules of FIG. 1A.

Further, the computing devices and servers of the content delivery system 100 may each include one or more processor-based computing devices, which may be configured to execute portions of the stored computer readable code or application modules stored within the content delivery system 100 to perform operations consistent with the disclosed embodiments, including operations consistent with the exemplary processes described herein, which may automatically and dynamically generate or modify digital insight content and trigger generation of one or more graphical user interfaces 106 for applications 104 on external computing devices, and connectivity with one or more additional devices in accordance with monitored data transfers and predictions made by the artificial neural network framework of the content delivery system 100 which may deliver one or more portions of the customized digital content to dynamically selected network-connected computing devices 102 through corresponding digital signals via the communication unit 127.

The machine learning models 116 may include but not limited to: regression models which define functions to describe relationships between the independent variables and a target variable, rule-based models, decision tree model, and tree based ensemble machine learning models including extreme gradient boosted models applying supervised learning for regression based prediction on the large data sets of data analyzed by the content delivery system 100. Each model 116 may be associated with predicted future performance metrics for a particular type or category of predicted data transfer. Thus, the model selector 118 may be configured to retrieve the data transfer attribute from the data and thereby select the associated model from a plurality of available machine learning models. For example, in the case of data transfers relating to variable expenses, the model selector 118, may select a plurality of extreme gradient boosted regression models based on supervised learning for regression and stored within the machine learning models 116, each trained to output projected variable expenses and an associated prediction interval. In the case of data transfers relating to fixed expenses prediction, the model selector 118 may select rule-based models from the machine learning models 116 specifically configured to output projected fixed expenses, and upcoming data transfers such as including date, merchant, and associated value. In the case of data transfers relating to incoming transactions, such as income, the model selector 118 may select a plurality of extreme gradient boosted regression models to predict projected income and associated prediction intervals. As will be described, at least some of the information generated by the prediction engine 114 may be displayed on the client application 104 via the user interface 106. In at least some implementations, the content delivery system 100 may further manipulate the predicted content from the prediction engine, such as to modify its formatting and presentation and generate associated digital insights and digital actions on the client applications 104.

Thus, the machine learning models 116 may in some aspects utilize supervised machine learning regression model, such as extreme gradient boosted models and be configured to predict future data transfers and transactions, including attributes (e.g. cash-flow associated with the one or more customer accounts held on the database system 112 relating to transactions performed by the client computing devices 102). In at least some aspects, the machine learning models 116 are trained based on prior historical transactions to predict future transaction in a given target window. For example, in the example of financial transactions, the prior transactions may include cash-flow changes and associated data relating to transactions debiting and crediting the one or more accounts.

The machine learning models 116 may thus predict future transactions, transaction attributes for a future time period. In the case of financial transactions, this may include predicting, cash-flow (e.g. net future increase or decrease in the balance of the one or more customer accounts) and cash-flow attributes (e.g. income, fixed expenses, and variable expenses) for a future time period (e.g. a month). For example, the cash flow predictions may include incoming (payroll); fixed expenses and variable expense predictions.

An example of a time schema for target definition of a supervised machine learning model implemented in the machine learning models 116 of FIG. 1A is shown in FIG. 1B, illustrating time windows for feature extraction, a target window, a buffer window and inference dates for prediction of future data transfer targets. Thus, the machine learning model 116 may be constructed such that a target window extends from an inference data (after buffer) to a future time. The model 116 may be run, every periodic time period to predict future data transfers in the target window. Also, a predefined window may be applied for feature extraction based on validating model performance on prior runs of the trained machine learning model.

Additionally, referring to FIG. 1C which illustrates an example data split for training the machine learning model 116 of FIG. 1A and includes out-of sample validation, out-of time validation used for training and generating the machine learning model 116 such as the supervised machine learning model using extreme gradient boosting. As illustrated in FIG. 1C, the training set used to generate the model has a sliding window which moves over a defined period of time, an out of sample set for in-time validation and an out of time set for testing the machine learning model 116. The feature and target windows are also shown as example in FIG. 1C.

Preferably, the machine learning model 116, implements a mixed machine learning model implementation to account for the different types of transaction data attributes and thus performs improved prediction which enables analyzing and processing different types of data based on training the model for that particular type of data. Conveniently, by utilizing a model selector 118 and a plurality of machine learning models 116 (e.g. a set of extreme gradient boosted models) each trained and configured for predicting a future performance metric (e.g. data transfer) for a particular type of data transfer, an improved performance may be reached.

In one aspect, the model 116, once trained may be used to extract therefrom a set of key factors (e.g. based on performing attribute contribution rating of the marginal contribution of attributes such as Shapley contributions) associated with future predicted performance metrics relating to the future data transfer predicted values for various categories.

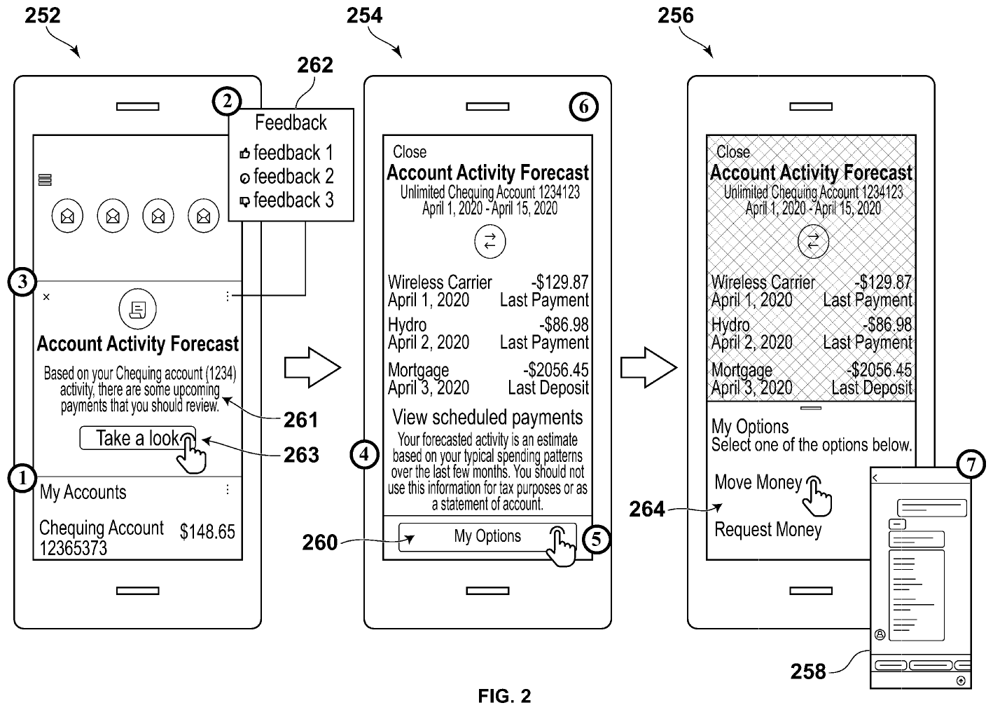

In one particular example, the model 116 dynamically predicts factors associated with debit and credit trend data likely to influence the predicted future cash-flow (e.g. periodic income payments from employment credited to the one or more customer account, periodic bill payments debited from the one or more customer accounts as shown in FIG. 2).

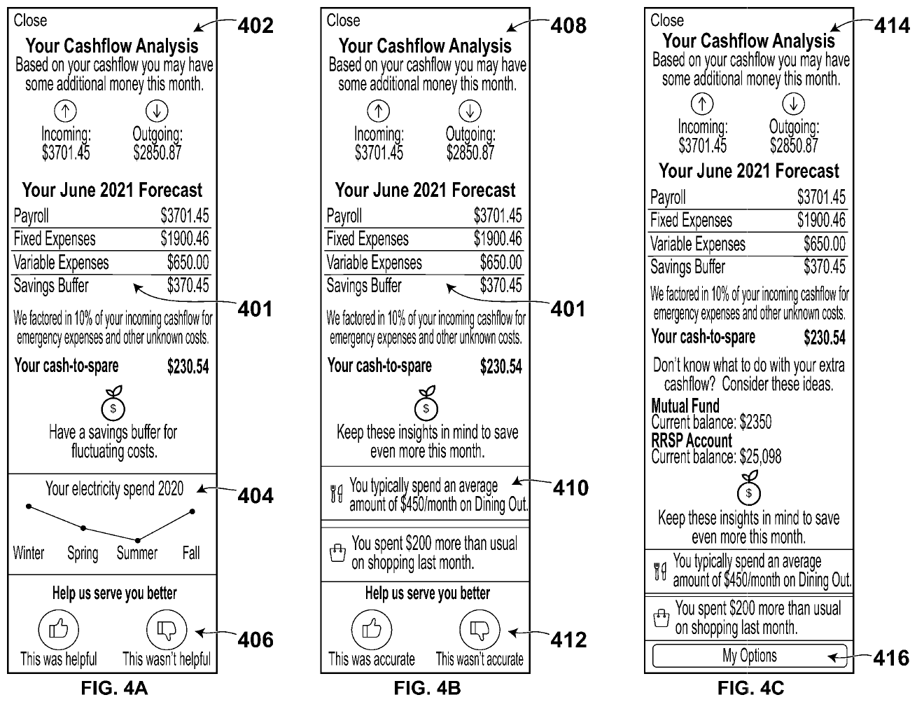

In addition to generating the predictions of data transfers, associated prediction intervals and data transfer types or attributes, the prediction engine 114 may be configured to generate, a confidence score associated with each prediction from the machine learning models 116. Such a confidence score may be generated for example, by the machine learning models 116 along with the prediction, based on prior test datasets and the proportion of correct predictions in a whole dataset in a testing phase of the machine learning model 116. The predictions provided from the prediction engine 114, may in at least some aspects be fed to (e.g. in the form of a nudge or triggering an action for display) one or more associated client computing devices 102, to visually display such predictions on the user interface 106 of the client application 104, such as shown in FIG. 4A, displaying in a first view 402, one or more predictions in the form of interactive visual icons in a first portion 404. As shown in the first view 402, the content delivery system 100 may further trigger the client computing device 102 to display on the user interface 106, one or more feedback icons, such as a first feedback icon 406, a second feedback icon 412, displayed to receive user input (e.g. positive, negative or neutral feedback or impression) on whether the digital view illustrated on the user interface 106, such as providing predictions, insights and customized actions on the user interface 106 are positively interacted with or not. Such feedback input may then be fed back to the content delivery system 100, for use by the feedback detection module 124 to dynamically revise and update the operation of the relevant modules generating the user interface (e.g. in the case of predictions, the prediction engine 114; in the case of insights, the insight generation module 122; in the case of visual action icons, the action generation module 120) and associated neural network models, such as in the machine learning model 116.

Referring back to FIG. 1A, the predictions from the prediction engine 114, may then be fed into an insight generation module 122. In some aspects, triggering such communication is initiated in response to positive feedback received on the user interface 106 in response to displaying the predictions (e.g. selecting the first feedback icon 406). Notably, the insight generation module 122 may further implement one or more machine learning models, including supervised learning models such as extreme gradient boosted models to generate, based on the predictions provided from the prediction engine 114 (e.g. predicted future data transfers, and data transfer attributes), a set of personalized digital insight content, in the form of visual insight icons containing the content to be presented on the user interface 106 of the client application 104. Upon generating the digital insights, the insight generation module 122 may then trigger the client computing device 102 to display same on the user interface 106. Such digital insights may be generated to reinforce digital transaction or data transfer behaviours in the networked environment of FIG. 1A. Referring to FIG. 4B, there is shown a second example view 408 of the user interface 106 for the client application 104, illustrating sample insights, such as a first set of digital insights 410. In general, the digital insights generated may indicate that the content delivery system 100 has accurately analyzed the digital behaviours of the one or more client computing devices 102 within a networked environment, such as that of FIG. 1A, including performing data transfers across the network. The digital insights may for example display digital analytical content based on capturing, and analyzing the data transfer patterns and predicting future trends and behaviours of the data transfers from the prediction engine 114. The digital insights provided by the insight generation module 122, may in some aspects, provide digital data and content to define how the predictions generated by the prediction engine 114 were generated and insights to indicate analytics on how other similar digital users improved similar data transfer predictions. The third example view 414 of FIG. 4C further illustrates additional view when one or more of the objects providing an initial set of insights and/or predicted output data transfer values are interacted with, such as to display a set of action icons (e.g. a first action icon 416) on the user interface 106 as shown in FIG. 4C, which may be generated via the action generation module 120.

Thus, one aspect of the embodiment of the insight generation module 122 includes triggering a presentation, e.g. on one or more client computing devices 102, of predicted future data transfer patterns (e.g. see forecasted first portion 401) and insights including one or more features associated with the historically influenced data transfer (e.g. cash flow patterns) as derived from the prediction engine 114 and the machine learning model 116 as well as factors likely to influence predicted future data transfer trends. Such digital insights based on past data transfers and future predictions may be presented, such as the first set of digital insights 410 displayed alongside the forecasted patterns of data transfers and associated attributes (e.g. see forecasted first portion 401) and the second feedback icon 412. Although the screen views 4A-4C illustrate digital insights related to financial transactions and attributes (e.g. variable, fixed, incoming, outgoing, etc.), as described herein, other data transfer types may be envisaged as described herein and triggered/presented for display on the user interfaces of associated computing devices.

Although FIG. 1A illustrates a single client computing device 102, a single data processing server 110 and a single delivery system 100, in some embodiments the networked computing environment can include multiple different user client computing devices 102, each associated with a different end user for associated client applications 104 and user interfaces 106, and the networked computing environment may also include additional data processing servers 110 and content delivery system 100 for handling data transfers and generating digital user interface content including digital insight objects and digital action icons for different groups of end users or client computing devices 102.

In one aspect, the insight generation module 122 may perform additional tracking and monitoring transaction behaviour of all computing devices (e.g. within the networked environment of FIG. 1A) such as to create a profile history repository 132 for all computing devices 102 storing a history of prior data transfer patterns and corresponding insights interacted with (e.g. having a positive feedback). Thus, the content delivery system 100 may store, via a customer profiling module 126, within the profile history repository 132, a set of profiles of end users (and associated one or more client computing devices 102) in the networked environment of FIG. 1A and associated data transfer patterns and digital behaviours. The information stored in the customer profiling module 126 may include user characteristics such as the user names, user identification, prior user interactions with client applications 104 and graphical user interfaces 106 including feedback received thereon in response to prior presented digital insight content and historical data transfer patterns (e.g. data transfers within each of the attribute types over a past time period), user preferences, and information relating to any previous user interactions via the client computing device 102 and/or the client applications 104 within the networked computing environment of FIG. 1A (e.g., requested data, provided data, data transfers performed in relation to one or more accounts held on the client applications 104, associated users and computing devices, etc.).

Thus, the customer profiling module 126 may access, in response a digital insight being generated by the insight generation module 122, the profile history repository 132 and determine a new device or user profile for which an insight is being generated should be grouped with other similar profiles (e.g. based on variability of data transfers and similarity of digital behaviours). The insight generation module 122 may then be configured to further customize the insights generated form the predictions of the prediction engine 114, responsive to a determination from the profiling module 126 that a given data transfer associated with a particular device and digital users is similar in profile to other device/user profiles and thereby generate digital insights accordingly. Thus, in one aspect, the insight generation module 122, may apply data transfer patterns extracted by way of the trained machine learning model 116, for the associated computing devices and use the customers grouped as similar to those under consideration to generate the digital insights, by way of the machine learning modules in the insight generation module 122. For example, such insights generated by the insight generation module 122 may provide analytical content (text, images, audio, and/or videos) on the user interface 106 that other device profiles (e.g. user) similar to the client of the client application 104 found such particular set of insights helpful (e.g. based on monitoring feedback from computing devices 102 by way of the feedback detection module 124) and thereby trigger the customized graphical user interface 106 displaying same. By way of example, user interfaces of computer devices on which the digital content providing the digital insights may be presented are shown in FIGS. 2, 3, 4A-4C, and 5A-5B.

In at least some aspects, the insight generation module 122 may further be configured to tailor the generated digital insights from one or more predictive machine learning models, which are initially generated based on the predicted data transfers and the user profiling of similar users having an associated set of successfully interacted with digital insights further based on a set of confidence scores. Notably, the prediction engine 114 may generate a set of confidence scores for the prediction indicative of the machine learning model 116 confidence level of the predicted future data transfer. Such confidence scores may be stored within a database such as a confidence score repository 128. Such confidence scores may then be used by the insight generation module 122 to determine the language and textual mapping of the insight based on same. In one aspect, the insight generation module 122, may access a content template repository 130 storing a mapping of textual content and/or portions of text and/or language along with associated confidence scores to be applied based on the confidence score. Thus, the insight generation module 122, may thus apply the confidence scores for predicted future data transfer predictions generated by the prediction engine 114 to determine the language/content of the insights retrieved.

Preferably, the insight generation module 122 generates the digital insights based on the metrics in the predicted data transfer provided by the prediction engine 114, and customized based on a determination of similar profiles for the data transfer and associated retrieved content previously determined as efficient for other similar profiles

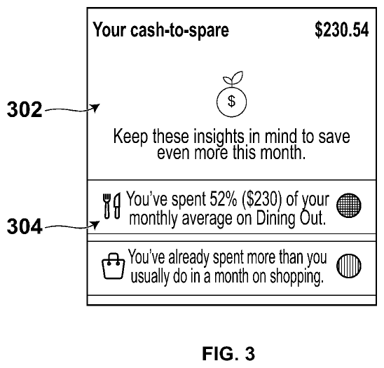

Referring to FIG. 3, shown is an example insight screen portion 302 of the user interface 106 indicating predicted future performance metrics for the data transfer, and an associated set of digital insights 304, generated by the neural network framework of the content delivery system 100.

In at least some aspects, the content delivery system 100, may be configured, via the insight generation module 122 to dynamically manage the contextual digital insights related to the data transfer predictions presented to the user interface 106 of the computing device 102 such that the presentation of the digital insight objects presented on the user interface screen (e.g. text, images, and/or video content) is dynamically adjusted based on the relative confidence score of the one or more factors and/or attributes used to derive the predicted output of the machine learning model 116 (as also output from the model 116).

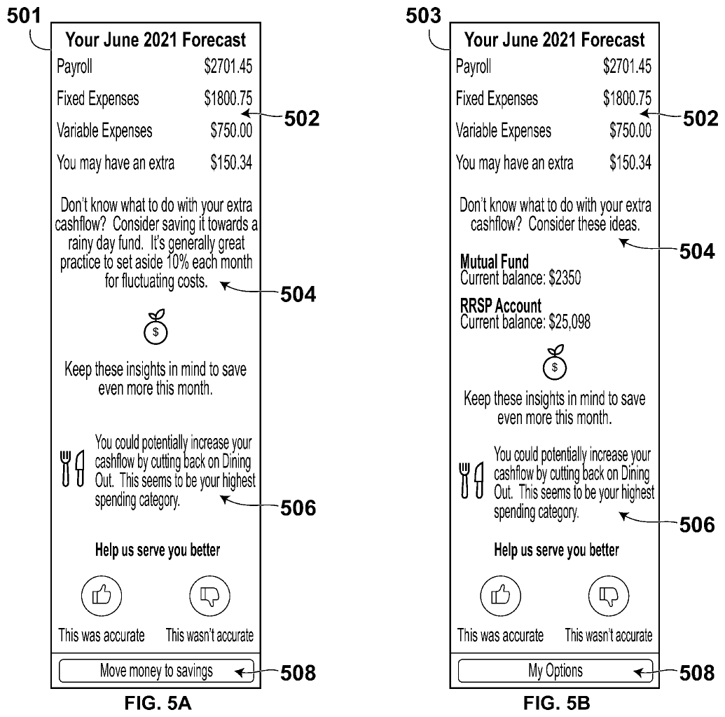

FIGS. 4B and 4C show example user interface screens of the computing device 102 whereby the objects presented on the user interface relating to digital insight content generated from the content delivery system 100 are dynamically managed such that different formats and content of digital insight objects are presented on the user interface screens based on a relative contribution score of different predicted outputs. In one example embodiment, where the prediction engine 114 generates a plurality of predictions for data transfers having different attributes (e.g. fixed, variable, etc.) then a different confidence score may be associated with each of the generated attributes and thus the insight generation module 122 may generate the digital insight objects based on accessing templates associated with a composite or average score of confidence for the attributes (e.g. as retrieved from the content template repository 130) to tailor the output digital insight objects and formatting displayed to the client computing devices 102. Similarly, FIGS. 5A and 5B illustrate two different example user interface screens 501 and 503 illustrating, in a first screen portion 502, the forecasted or predicted data transfer outputs for various different attribute categories, as generated by the trained machine learning model 116 whereby each category is generated via a different machine learning model selected by the model selector 118. In a second screen portion 504, a plurality of objects containing insight digital content (e.g. text, image, video) are presented having different formats and/or language and/or template of the content. As described herein, the digital insight format and content may be tailored as selected by the insight generation module 122, based on an aggregate or average of the confidence score generated by the prediction engine 114 of FIG. 1A, for each of the predicted categories of data transfer and determining based on continually monitoring feedback of the client computing devices 102, prior digital insight objects that were successfully engaged with in prior iterations of the content delivery system 100 and using same for delivering content that was previously successful for other similar parties (e.g. source and destination devices) involved in the data transfer, as determined by the customer profiling module 126. Examples of different digital insight content 506 is illustrated in FIGS. 5A and 5B. Additionally, the user interface screens 501 and 503 illustrate different action icons 508 generated by the action generation module 120 based on the insights provided by the insight generation module 122 and thereby extracting a set of associated actions (e.g. from the content template repository 130) previously determined to improve one or more of the predicted data transfer types generated by the prediction engine 114.

Referring again to FIG. 1A, in some aspects, when one or more digital insight objects (e.g. text, audio, video, image content) presented on the user interfaces 106 of the client application 104 are interacted with or otherwise “selected” such as by clicking the icon, then such feedback may be detected via the feedback detection module 124 and trigger the generation of one or more action icons on the user interface 106 to perform computerized actions related to the data transfer and preferably, to improve the predicted performance metrics of the output of the prediction engine 114 and to perform at least one related subsequent data transfer action within the networked computing environment of FIG. 1B. A click or selection of the digital insight icons or associated icons may refer to a user selection or an automatic selection of a particular item of digital insight content. Such feedback may include any digital impressions received in response to presenting the one or more digital insights on the interactive user screens of the client applications 104. In one example, referring to FIG. 2, a first screen 252 illustrates digital insights and/or forecasted future data transfer metrics as textual and/or image content on the screen which may be further interacted with, via selection of an information icon 263 to trigger generation, via the feedback detection module 124, of additional action icons (e.g. 260, 264 and 268) shown in the second screen 254 and the third screen 256 of the graphical user interface 106. In another example, referring to FIG. 4A, when the first feedback icon 406 is interacted with then a subsequent more detailed screen as shown in FIG. 4B may illustrate an additional set of insights as generated by the insight generation module 122, and when the one or more interactive insight object icons on the screen of FIG. 4B are interacted with then one or more action icons, such as a first action icon 416 providing an option to select and perform one or more computerized action via the third example view 414 in FIG. 4C may be displayed.

Referring again to FIG. 1A, the content delivery system 100 may thus further include the feedback detection module 124, the feedback detection module 124 may cooperate with an insight generation module 122 and an action generation module 120 to adjust the one or more visual objects containing insights by displaying objects for triggering computerized actions on the user interface 106. An aspect of the disclosure for the content delivery system 100 may further comprise tracking feedback received from input on the client computing device 102 application 104 in response to the insight which includes determining whether a positive or a negative response (e.g. indicating a presented insight as helpful or not such as via first and second feedback icons 406 and 412) was received on the user interface 106.

In one or more aspects, the action generation module 120 may further dynamically determine one or more subsequent actions to improve the predicted future data transfer metrics associated with one or more data records for the client application 104, and present the computerized actions as selectable icons to the user interface of the client computing device 102 (e.g. as shown in the example user interface in FIG. 2, FIGS. 4C and 5B).

Referring to FIG. 2, there is illustrated a schematic diagram showing an example flow of operations and a corresponding series of interface screens, shown as a first screen 252, a second screen 254, and a third screen 256 illustrating different instances and example views of the user interface 106 for the client application 104, in accordance with one example embodiment. Initially, at a first step 1, the content delivery system 100 triggers the display of the first screen 252 via a targeted and personalized digital nudge (e.g. a push notification provided from the content delivery system 100 to the client computing device 102 across the communications network 108) providing digital content including predicted future data transfer content 261 and in some aspects, an initial digital insight related to the predicted future data transfer values, which when selected triggers the additional display of a set of feedback icons at second step 2, shown as a menu of feedback options 262. At step 3, the feedback input received on the user interface screen is acknowledged and fed back from the client computing device 102 to the feedback detection module 124 for generating digital insight content via insight generation module 122. At step 4, an additional interface screen may be presented in response to the prior feedback allowing navigation of an end to end experience, including presenting one or more selectable initial action icons 260, as provided by the action generation module 120 along with forecasted future data transfer values for various categories at step 5. The action icons, provide proactive guided steps for the user interface to improve one or more of the forecasted objects displayed and perform associated computerized operation. At step 6, the set of objects displayed may be dynamically updated as additional feedback is received for the content delivery system 100. At step 7, by selecting the action icons 260, additional action icons 264 may be displayed as triggered via the feedback detection module 124 in cooperation with the action generation module 120 providing further actions and such selection triggering, at step 7, connection of the client computing device 102 via the client application 104 to one or more other computing devices and digital platforms (e.g. digital applications such as social networking or communication applications). This may trigger the display of additional display screens 258 illustrating connection of the client application to navigate automatically to one or more other digital platforms (e.g. a messaging application for performing messaging related to the data transfer insight detected) for performing subsequent actions as triggered by the content delivery system 100 in response to the navigation of prior action icons.

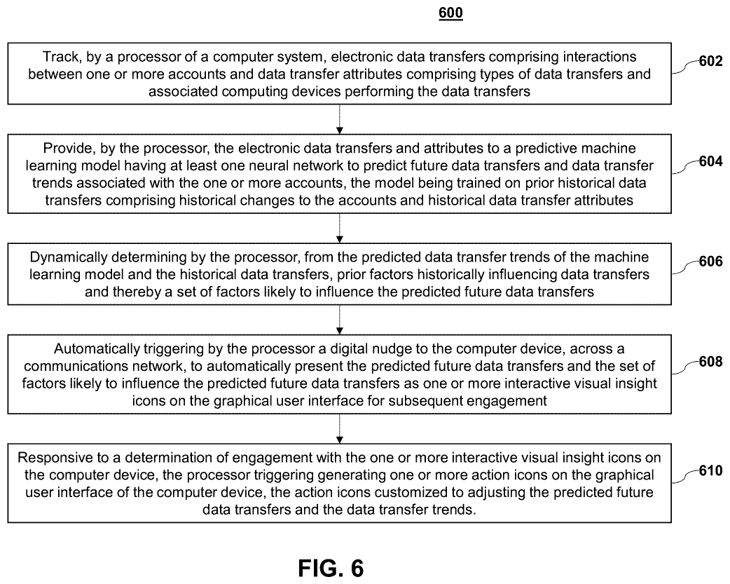

Referring to FIG. 6 shown is an example flow of operations 600 illustrating a method for the content delivery system 100 of FIG. 1A implementing the prediction engine 114 for generating dynamic digital content relating to data transfer predictions and triggering generation of a customized user interface containing the digital content proactively in a networked client computing device 102. In at least some aspects, a non-transitory computer readable medium stored on the content delivery system 100 can comprise instructions, that when executed by one or more processors 123, cause a computing device to perform the operations of FIG. 6. The content delivery system 100 may comprise a processor configured to communicate with one or more client computing devices 102 across a networked environment to generate digital content and objects to provide a graphical user interface 106 thereon.

At operation 602, operations comprise tracking by a processor 123 of a computer system such as the content delivery system 100, electronic data transfers (e.g. data transactions including but not limited to: communication transactions, social media transactions, data security transactions, other computerized transactions involving a source and destination device and associated data transfers, etc. in a network computing environment such as that shown in FIG. 1A). The electronic data transfers may comprise interactions between one or more data records (e.g. accounts held on various client computing devices 102 for client applications 104) and data transfer attributes comprising types of data transfers (e.g. variable, fixed, incoming, outgoing, data security, etc.) and associated computing devices (e.g. one or more networked client computing devices 102) performing the data transfers. In at least some aspects, the tracking of the data transfers and the collected data may be done as a collaboration and cooperation between the content delivery system 100 and one or more data processing servers 110, storing at least some of the data transfer data and associated user and device profiles within one or more data records on the database systems 112.

Following operation 602, upon receiving the data transfer information, operation 604 comprises providing by the processor 123 of the content delivery system 100, the electronic data transfers and attributes to a predictive engine 114 having one or more machine learning models 116 (e.g. at least one neural network) to predict future data transfers over a future time interval and associated with the one or more accounts or data records for the data transfers. The one or more machine learning models 116 are specifically trained, e.g. using supervised machine learning, on prior historical data transfers comprising historical changes to the accounts and historical data transfer attributes. Preferably, the machine learning models 116 are each specifically selected to address and predict a particular type of data transfer and utilize regression predictive modelling such as extreme gradient boosted models for each of the attribute types.

Following operation 604 at operation 606, the processor 123 is configured to dynamically determine, from the output of the prediction engine 114 including predicted data transfer trends from the machine learning model(s) 116 and the historical data transfers (e.g. as obtained from the data processing server 110 and/or tracked via monitoring operations of the client computing devices 102), prior factors historically influencing data transfers and thereby a set of factors likely to influence the predicted future data transfers, the factors being associated with particular types of data transfers. Such factors may be extracted from the machine learning model 116 once trained and tested to predict data transfers and associated time intervals in a future time period.

Following operation 606, at operation 608, the processor 123 is configured to automatically trigger a computer signal across a communications network 108 (e.g. a push signal or a digital nudge) to the client computing device 102 to trigger automatically presenting the predicted future data transfers and the set of factors likely to influence the predicted future data transfers as one or more interactive visual insight icons on the graphical user interface 106 for subsequent engagement (e.g.

see also FIGS. 2, 3, 4A, 5A and 5B illustrating example operation of an initial digital nudge and associated graphical user interface displays generated).

Following operation 608, at operation 610, the processor 123 is configured, responsive to a determination of engagement with the one or more interactive visual insight icons on the client application(s) 104 of the client computing device 102, to trigger generating one or more action icons (e.g. see example action icons and corresponding digital content in FIGS. 2, 4C, 5A and 5B) on the graphical user interface 106 of the client computer device 102. In at least some aspects, the one or more action icons (e.g. for performing digital actions in response to their selection) are generated dynamically by the content delivery system 100 based on tracking network activity relating to data transfers and prior interactions with the client applications 104 (e.g. including positive, neutral and negative digital feedback received thereon) and customized to adjusting the predicted future data transfers and the data transfer trends, e.g. such as to improve performance metrics for one or more data transfer attributes. As described earlier, the content delivery system 100 may utilize the insight generation module 122 in collaboration with the feedback detection module 124, the customer profiling module 126, and the action generation module 120 to automatically generate and modify digital content related to data transfer predictions and associated digital actions in accordance with the operations of one or more client computing devices 102 operating in a networked computing environment.

In at least some aspects, the generation of digital action icons (e.g. providing proactive digital guidance of navigating the client application 104) may also include the content delivery system 100, via the action generation module 120 automatically causing the associated client computing device 102 for which the digital content is being generated, to automatically connect from the client application 104 to one or more other digital platforms and associated software applications (e.g. social media platforms, media sharing platforms, service oriented platforms, digital communication platforms). An example of this is illustrated in the flow of operations of FIG. 2, wherein at step 7, the content delivery system 100 causes, in response to detecting feedback on the insight icons and/or action icons presented on one or more screens (e.g. second screen 254 and third screen 256), to automatically connect to additional digital platforms (e.g. such digital platforms may be stored on the current client computing device 102 and/or accessed via other computing devices of the networked computing environment of FIG. 1A). The digital platform may refer to software and/or hardware based online infrastructure and applications which facilitate transactions and communications between client computing devices 102 and/or computing devices of the networked environment of FIG. 1A. Such digital platform connection triggered by the content delivery system 100, as per the methods described herein conveniently provides an enhanced digital user interface with enhanced digital content and connectivity operation to proactively and automatically connect to relevant digital platforms and applications based on extracted and predicted digital insights provided by the neural network framework of the content delivery system 100.

While this specification contains many specifics, these should not be construed as limitations, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow. Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit.

Instructions may be executed by one or more processors, such as one or more general purpose microprocessors, application specific integrated circuits (ASICs), field programmable logic arrays (FPGAs), digital signal processors (DSPs), or other similar integrated or discrete logic circuitry. The term “processor,” as used herein may refer to any of the foregoing examples or any other suitable structure to implement the described techniques. In addition, in some aspects, the functionality described may be provided within dedicated software modules and/or hardware. Also, the techniques could be fully implemented in one or more circuits or logic elements. The techniques of this disclosure may be implemented in a wide variety of devices or apparatuses, an integrated circuit (IC) or a set of ICs (e.g., a chip set).

One or more currently preferred embodiments have been described by way of example. It will be apparent to persons skilled in the art that a number of variations and modifications can be made without departing from the scope of the invention as defined in the claims.

One or more currently preferred embodiments have been described by way of example. It will be apparent to persons skilled in the art that a number of variations and modifications can be made without departing from the scope of the invention as defined in the claims.

What is claimed is:

1. A computer system for presenting actionable icons on a graphical user interface (GUI) of a computer device, the computer system comprising:
at least one processor; and
a memory in communication with the at least one processor, the memory storing instructions, that when executed by the at least one processor, configure the system to:
track electronic data transfers comprising interactions between one or more data records and data transfer attributes comprising types of data transfers and associated computing devices performing the data transfers;
provide the electronic data transfers and attributes to a predictive machine learning model having at least one neural network to predict future data transfers and data transfer trends associated with the one or more data records, the model being trained on prior historical data transfers comprising historical changes to the data records and historical data transfer attributes;
dynamically determine from the predicted data transfer trends of the machine learning model and the historical data transfers, prior factors historically influencing data transfers and thereby a set of factors likely to influence the predicted future data transfers;
automatically trigger a digital nudge to the computer device, across a communications network, to automatically present the predicted future data transfers and the set of factors likely to influence the predicted future data transfers as one or more interactive visual insight icons on the graphical user interface for subsequent engagement; and,
responsive to a determination of engagement with the one or more interactive visual insight icons on the computer device, the processor triggering generating one or more action icons on the graphical user interface of the computer device, the action icons customized to adjusting the predicted future data transfers and the data transfer trends.

2. The system of claim 1, wherein the data transfer attributes comprise: movement of data transfers between the one or more data records, and at least one credit and one debit posting in the one or more data records.

3. The system of claim 1, wherein triggering the presenting further comprises: trigger presenting of the set of factors alongside prior factors historically influencing the data transfers on the graphical user interface for subsequent engagement.

4. The system of claim 1, wherein a determination of engagement, further comprises:
tracking feedback input received on the graphical user interface of the computer device comprising:
determining whether a positive response indicating the visual insight icons comprising a set of data transfer insights as helpful; a neutral response indicating the visual insight icons comprising the data transfer insights were not interacted with; or a negative response indicating the visual insight icons comprising the data transfer insights were unhelpful was received on the graphical user interface of the computer device.

5. The system of claim 4, wherein the instructions further configure the system to:
transmit the feedback input to the predictive machine learning model to invoke the predictive machine learning model to revise the training of the model based on the feedback input and thereby update the set of factors; and,
responsive to retraining the model, trigger the graphical user interface of the computing device to display an updated visual insight icons comprising the updated set of factors.

6. The system of claim 5, wherein presenting the visual insight icons further comprises the instructions configuring the system to:
dynamically generate content for the visual insight icons further based on: extracting, from a database, profile attributes of a user associated with the electronic data transfers for the one or more data records;
determine, from the database, similar users based on the profile attributes of the user; grouping the similar users into clusters on the database; and
responsive to said grouping, generate similar content for the visual insight icons for the similar users based on historical knowledge of insights having a positive rating by prior users.

7. The system of claim 6, wherein the instructions further configure the system to:
determine, from the predictive machine learning model, a degree of confidence related to the predicted future data transfers and retrieve a set of corresponding templates from the database for presenting the one or more interactive visual insight icons based on the degree of confidence wherein each of the templates is defined as associated with a range of degree of confidence.

8. The system of claim 1 wherein generating the one or more action icons further comprises the instructions configuring the system to: dynamically determine one or more potential actions relating to interacting with the one or more data records to improve the predicted future data transfers associated with the one or more data records, and present the actions as content for the action icons to graphical user interface of the computing device.

9. The system of claim 1, wherein the instructions further configure the system to:
select a first trained neural network from a plurality of trained neural networks to predict the future data transfers based on the data transfer attributes, wherein different predicted future data transfers are predicted associated with a particular category of data transfer attributes.

10. The system of claim 9, wherein the first trained neural network comprises at least one of: a regression model, a rule-based model, and a decision tree based ensemble model using gradient boosting framework.

11. The system of claim 1, wherein the instructions further configure the system to: determine a confidence score for the set of factors likely to influence the predicted future data transfers; and dynamically manage and adjust a presentation of insights presented in the one or more interactive visual insight icons on the graphical user interface based on the determined confidence score of the set of factors.

12. A computer implemented method for presenting actionable icons on a graphical user interface (GUI) of a computer device, the method comprising:
tracking, by a processor of a computer system, electronic data transfers comprising interactions between one or more data records and data transfer attributes comprising types of data transfers and associated computing devices performing the data transfers;
providing, by the processor, the electronic data transfers and attributes to a predictive machine learning model having at least one neural network to predict future data transfers and data transfer trends associated with the one or more data records, the model being trained on prior historical data transfers comprising historical changes to the data records and historical data transfer attributes;
dynamically determining by the processor, from the predicted data transfer trends of the machine learning model and the historical data transfers, prior factors historically influencing data transfers and thereby a set of factors likely to influence the predicted future data transfers;
automatically triggering by the processor a digital nudge to the computer device, across a communications network, to automatically present the predicted future data transfers and the set of factors likely to influence the predicted future data transfers as one or more interactive visual insight icons on the graphical user interface for subsequent engagement; and,
responsive to a determination of engagement with the one or more interactive visual insight icons on the computer device, the processor triggering generating one or more action icons on the graphical user interface of the computer device, the action icons customized to adjusting the predicted future data transfers and the data transfer trends.

13. The method of claim 12, wherein the data transfer attributes comprise: movement of data transfers between the one or more data records, and at least one credit and one debit posting in the one or more data records.

14. The method of claim 12, wherein triggering the presenting further comprises: trigger presenting of the set of factors alongside prior factors historically influencing the data transfers on the graphical user interface for subsequent engagement.

15. The method of claim 12, wherein a determination of engagement, further comprises:
tracking feedback input received on the graphical user interface of the computer device comprising:
determining whether a positive response indicating the visual insight icons comprising a set of data transfer insights as helpful; a neutral response indicating the visual insight icons comprising the data transfer insights were not interacted with; or a negative response indicating the visual insight icons comprising the data transfer insights were unhelpful was received on the graphical user interface of the computer device.

16. The method of claim 15, further comprising:
transmitting the feedback input to the predictive machine learning model to invoke the predictive machine learning model to revise the training of the model based on the feedback input and thereby update the set of factors; and,
responsive to retraining the model, triggering the graphical user interface of the computing device to display an updated visual insight icons comprising the updated set of factors.

17. The method of claim 16, wherein presenting the visual insight icons further comprises:
dynamically generating content for the visual insight icons further based on: extracting, from a database, profile attributes of a user associated with the electronic data transfers for the one or more data records;
determining, from the database, similar users based on the profile attributes of the user; grouping the similar users into clusters on the database; and
responsive to said grouping, generating similar content for the visual insight icons for the similar users based on historical knowledge of insights having a positive rating by prior users.

18. The method of claim 17 further comprising:
determining, from the predictive machine learning model, a degree of confidence related to the predicted future data transfers and retrieving a set of corresponding templates from the database for presenting the one or more interactive visual insight icons based on the degree of confidence wherein each of the templates is defined as associated with a range of degree of confidence.

19. The method of claim 12 wherein generating the one or more action icons further comprises: dynamically determining one or more potential actions relating to interacting with the one or more data records to improve the predicted future data transfers associated with the one or more data records, and presenting the actions as content for the action icons to graphical user interface of the computing device.

20. The method of claim 12 further comprising:
selecting a first trained neural network from a plurality of trained neural networks to predict the future data transfers based on the data transfer attributes, wherein different predicted future data transfers are predicted associated with a particular category of data transfer attributes.

21. The method of claim 20, wherein the first trained neural network comprises at least one of: a regression model, a rule-based model, and a decision tree based ensemble model using gradient boosting framework.

22. The method of claim 12, further comprising: determining a confidence score for the set of factors likely to influence the predicted future data transfers; and dynamically managing and adjusting a presentation of insights presented in the one or more interactive visual insight icons on the graphical user interface based on the determined confidence score of the set of factors.

23. A system comprising:
a prediction engine comprising: a plurality of neural network models each configured to determine for a corresponding category of data transfer between computing devices comprising fixed and variable incoming and outgoing data transfers in an input data transfer data set, a predicted set of future data transfers comprising: a future data transfer value for a future time period within each said category of data transfer and an associated confidence score for the future data transfer value being predicted, each neural network model trained for a particular category of data transfer with prior historical data transfer data;
a profiling module for determining historical user profiles similar to a user profile associated with the input data transfer data set;
an insight generation module to produce from the future data transfer value for each said category of data transfer and the historical user profiles, a set of potential interactive visual insights for display on a user interface associated with a computing device of the input data transfer data set;
a content generation module to produce customized interactive content on the user interface selected based on the set of potential interactive visual insights and the confidence score, the customized interactive content being presented on the user interface as visual insight icons for selection and engagement on the user interface; and,
a feedback detection module to track engagement on the user interface with the visual insight icons and generate a set of action icons on the user interface, the action icons selected to perform a set of data transfers determined, by the feedback detection module, to improve the predicted set of future data transfers based on the engagement on the user interface.

24. A tangible, non-transitory computer-readable medium storing instructions that, when executed by at least one processor, perform a method for presenting actionable icons on a graphical user interface (GUI) of a computer device comprising:
tracking, by a processor of a computer system, electronic data transfers comprising interactions between one or more data records and data transfer attributes comprising types of data transfers and associated computing devices performing the data transfers;
providing, by the processor, the electronic data transfers and attributes to a predictive machine learning model having at least one neural network to predict future data transfers and data transfer trends associated with the one or more data records, the model being trained on prior historical data transfers comprising historical changes to the data records and historical data transfer attributes;
dynamically determining by the processor, from the predicted data transfer trends of the machine learning model and the historical data transfers, prior factors historically influencing data transfers and thereby a set of factors likely to influence the predicted future data transfers;
automatically triggering by the processor a digital nudge to the computer device, across a communications network, to automatically present the predicted future data transfers and the set of factors likely to influence the predicted future data transfers as one or more interactive visual insight icons on the graphical user interface for subsequent engagement; and,
responsive to a determination of engagement with the one or more interactive visual insight icons on the computer device, the processor triggering generating one or more action icons on the graphical user interface of the computer device, the action icons customized to adjusting the predicted future data transfers and the data transfer trends.
